(19) United States
(12) Patent Application Publication
(10) Pub. No.: US 2026/0249936 A1
(43) Pub. Date: Aug. 27, 2026

(54) TANDEM AXLE TRAILER LIFT DEVICE

(71) Applicant: David Lacour, Harvey, LA (US)

(72) Inventor: David Lacour, Harvey, LA (US)

(21) Appl. No.: 19/060,125

(22) Filed: Feb. 21, 2025

(51) Int. Cl. B62D 61/12

(52) U.S. Cl. CPC B62D 61/125

(57) ABSTRACT

A tandem axle trailer lift device includes a tandem axle trailer and a first axle and a second axle which is pivotally attached to the tandem axle trailer. The second axle is positionable in a lowered position or a lifted position. A pair of wheels is rotatably disposed on the second axle to roll along a support surface when the second axle is in the lowered position. Each wheel is lifted upwardly from the support surface when the second axle is in the lifted position such that a user can steer the tandem axle trailer on wheels of the first axle. A drive box is mounted to the tandem axle trailer and the drive box is in mechanical communication with the second axle. A crank is releasably mateable to the drive box which can be rotated to urge the second axle between the lowered position and the lifted position.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to trailer lift devices and more particularly pertains to a new trailer lift device for lifting wheels of a tandem axle trailer such that a user can steer the tandem axle trailer when the user is pushing the tandem axle trailer. The device includes a tandem axle trailer and a first axle attached to the tandem axle trailer and a second axle pivotally attached to the tandem axle trailer. The second axle is pivotal between a lowered position having wheels on the second axle roll along a support surface and a lifted position having the wheels on the second axle lifted from the support surface. The device includes a drive box that is in mechanical communication with the second axle and a crank that is removably mateable to the drive box for moving the second axle between the lowered position and the lifted position when the crank is rotated.

### (2) Description of Related Art Including Information Disclosed Under 37 CFR 1.97 and 1.98

The prior art relates to trailer lift devices including: a retractable caster device that includes a caster that is pivotally attached to a trailer which can be pivoted between a deployed position or a stored position; a liftable tandem axle suspension which includes trailer frame that has a central trunnion frame and a non-liftable axle mounted to the central trunnion frame and a liftable axle mounted to the central trunnion frame which can be lifted when the trailer is not loaded. In no instance does the prior art disclose a tandem axle trailer lift device that includes a tandem axle trailer and a first axle coupled to the tandem axle trailer and a second axle pivotally attached to the tandem axle trailer and a drive box attached to the tandem axle trailer that is in mechanical communication with the second axle and a crank that is mateable to the drive box for either lifting wheels on the second axle up from a support surface or lowering the wheels on the second axle onto the support surface when the crank is rotated.

### (h) BRIEF SUMMARY OF THE INVENTION

An embodiment of the disclosure meets the needs presented above by generally comprising a tandem axle trailer and a first axle and a second axle which is pivotally attached to the tandem axle trailer. The second axle is positionable in a lowered position or a lifted position. A pair of wheels is rotatably disposed on the second axle to roll along a support surface when the second axle is in the lowered position. Each wheel is lifted upwardly from the support surface when the second axle is in the lifted position such that a user can steer the tandem axle trailer on wheels of the first axle. A drive box is mounted to the tandem axle trailer and the drive box is in mechanical communication with the second axle. A crank is releasably mateable to the drive box which can be rotated to urge the second axle between the lowered position and the lifted position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a left side perspective view of a tandem axle trailer lift device according to an embodiment of the disclosure.

FIG. 2 is a magnified detail view taken from circle 2 of FIG. 1 of an embodiment of the disclosure showing a second axle in a lowered position.

FIG. 3 is a magnified detail view taken from circle 2 of FIG. 1 of an embodiment of the disclosure showing a second axle in a lifted position.

FIG. 4 is a bottom view of an embodiment of the disclosure.

FIG. 5 is a back view of an embodiment of the disclosure.

FIG. 6 is a left side view of an alternative embodiment of the disclosure.

FIG. 7 is a right side view of an alternative embodiment of the disclosure.

FIG. 8 is a right side view of an alternative embodiment of the disclosure showing a second axle being lifted into a lifted position.

FIG. 9 is a top view of an alternative embodiment of the disclosure.

FIG. 10 is a cross sectional view taken along line 10-10 of FIG. 9 of an embodiment of the disclosure.

FIG. 11 is a cross sectional view taken along line 11-11 of FIG. 4 of an embodiment of the disclosure.

### (j) DETAILED DESCRIPTION OF THE INVENTION

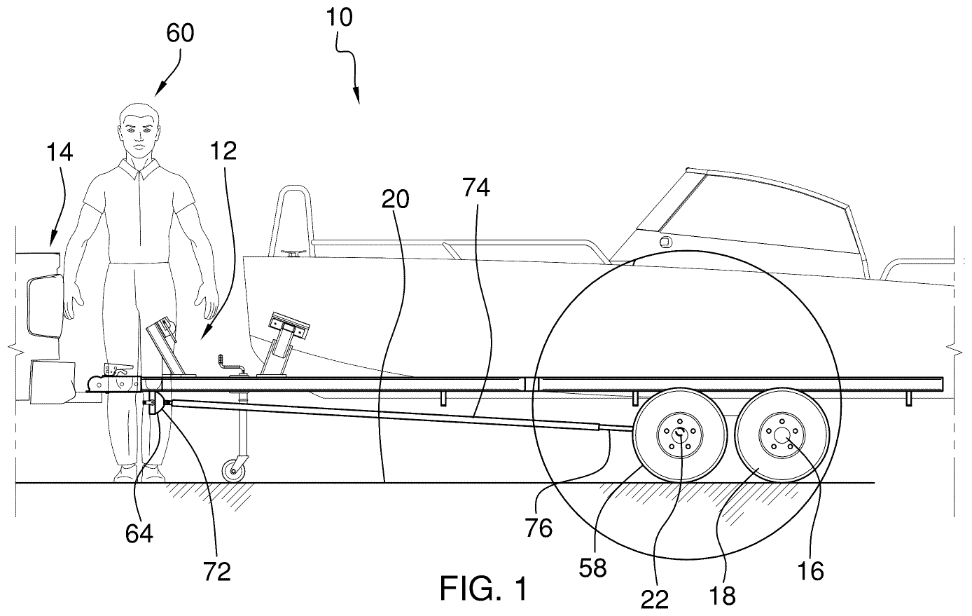

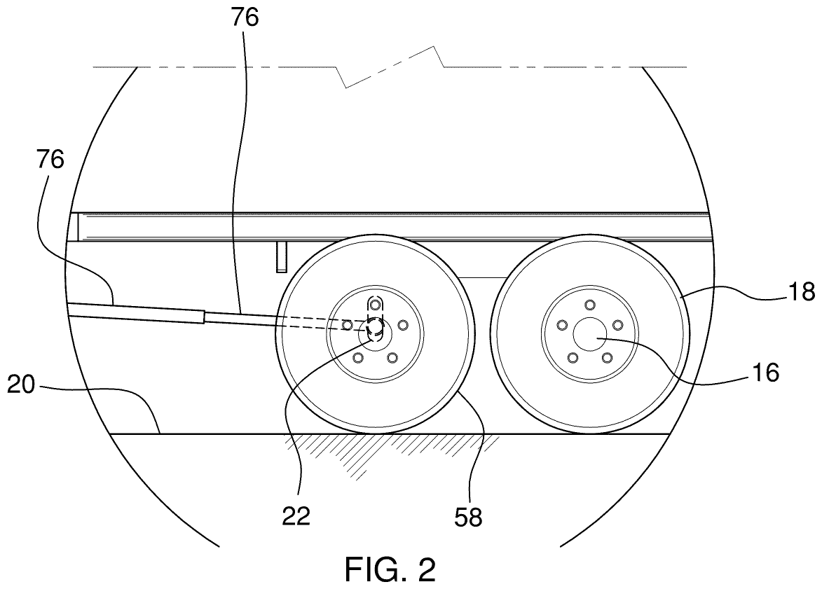

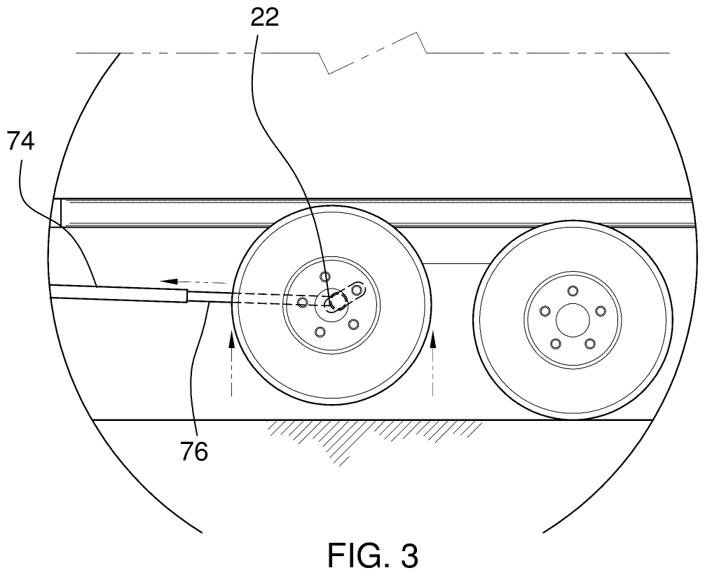

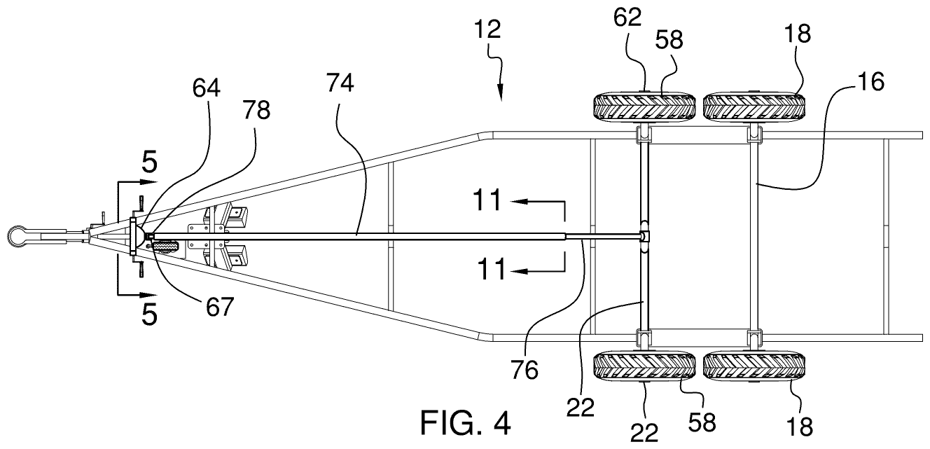

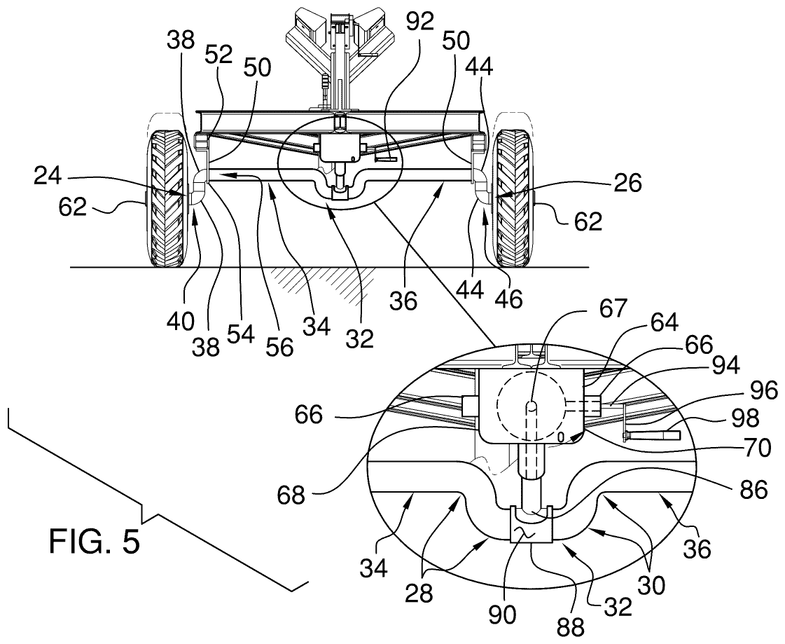

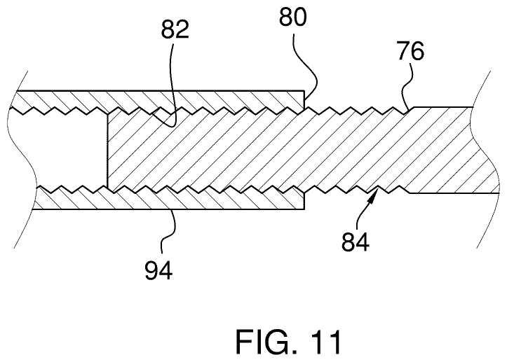

With reference now to the drawings, and in particular to FIGS. 1 through 11 thereof, a new trailer lift device embodying the principles and concepts of an embodiment of the disclosure and generally designated by the reference numeral 10 will be described.

As best illustrated in FIGS. 1 through 11, the tandem axle trailer lift device 10 generally comprises a tandem axle trailer 12 which can be towed with a privately owned tow vehicle 14, including but not being limited to a pickup truck, for example. The tandem axle trailer 12 may be a boat trailer or other type of tandem axle trailer which has a cargo capacity that is appropriate for the gross towing limit of the privately owned tow vehicle 14. A first axle 16 is mounted to the tandem axle trailer 12 and a pair of first wheels 18 is each rotatably disposed on the first axle 16 to roll along a support surface 20. The support surface 20 may be the ground, a concrete boat ramp or any other horizontal support surface 20 which the tandem axle trailer 12 is likely to encounter.

A second axle 22 is provided and the second axle 22 is pivotally attached to the tandem axle trailer 12. The second axle 22 is positionable in a lowered position and the second axle 22 is positionable in a lifted position. Each of the first axle 16 and the second axle 22 may comprise a torsion axle or other type of axle that does not employ a leaf spring suspension. The second axle 22 has a first end 24 and a second end 26; the second axle 22 has a pair of first bends 28 and the second axle 22 has a pair of second bends 30. The pair of first bends 28 curve in opposite directions from each other and the pair of second bends 30 curve in opposite directions from each other. Furthermore, the pair of first bends 28 is positioned closer to the first end 24 than the second end 26 and the pair of second bends 30 is positioned closer to the second end 26 than the first end 24.

The pair of first bends 28 and the pair of second bends 30 define a medial section 32 of the second axle 22 which extends between each of a first outward section 34 of the second axle 22 and a second outward section 36 of the second axle 22. The first outward section 34 extends from the medial section 32 toward the first end 24 and the second outward section 36 extends from the medial section 32 toward the second end 26. Furthermore, the medial section 32 extends along a lengthwise axis which is oriented parallel to a lengthwise axis of the first outward section 34 and a lengthwise axis of the second outward section 36.

The second axle 22 has a pair of third bends 38 and the pair of third bends 38 curve in opposite directions from each other. Additionally, the pair of third bends 38 is positioned closer to the first end 24 than the pair of first bends 28. The pair of third bends 38 define a first coupling section 40 of the second axle 22 and the first coupling section 40 extends between an outermost one of the pair of third bends 38 and the first end 24. Furthermore, the first coupling section 40 extends along a lengthwise axis is aligned with the lengthwise axis of the medial section 32.

The second axle 22 has a pair of fourth bends 44 and the pair of fourth bends 44 curve in opposite directions from each other. Additionally, the pair of fourth bends 44 is positioned closer to the second end 26 than the pair of second bends 30. The pair of fourth bends 44 define a second coupling section 46 of the second axle 22 and the second coupling section 46 extends between an outermost one of the pair of fourth bends 44 and the second end 26. Furthermore, the second coupling section 46 extends along a lengthwise axis which is aligned with the lengthwise axis of the medial section 32. Each of the medial section 32 and the first coupling section 40 and the second coupling section 46 is spaced downwardly from each of the first outward section 34 and the second outward section 36 when the second axle 22 is in the lowered position. Conversely, each of the medial section 32 and the first coupling section 40 and the second coupling section 46 is spaced forwardly from each of the first outward section 34 and the second outward section 36 when the second axle 22 is in the lifted position.

A pair of hangers 50 is provided and each hanger of the pair of hangers 50 has an upper end 52 which is coupled to the tandem axle trailer 12. Each hanger of the pair of hangers 50 extends downwardly from the tandem axle trailer 12 and each hanger of the pair of hangers 50 has a lower end 54. Additionally, each hanger of the pair of hangers 50 has a pivot point 56 which is aligned with the lower end 54. The first outward section 34 of the second axle 22 extends through the pivot point 56 of a respective one of the pair of hangers 50 and the second outward section 36 of the second axle 22 extends through the pivot point 56 of a respective one of the pair of hangers 50. Furthermore, the second axle 22 rotates about the lengthwise axis of the first outward section 34 and the lengthwise axis of the second outward section 36 when the second axle 22 is moved between the lowered position and the lifted position.

A pair of second wheels 58 is each rotatably disposed on the second axle 22 to roll along the support surface 20 when the second axle 22 is in the lowered position. Conversely, each second wheel 58 of the pair of second wheels 58 is lifted upwardly with respect to the pair of first wheels 18 when the second axle 22 is in the lifted position. Furthermore, each second wheel 58 of the pair of second wheels 58 is lifted from the support surface 20 such that a user 60 can steer the tandem axle trailer 12 on the pair of first wheels 18 when the second axle 22 is in the lifted position. The tandem axle trailer 12 will readily pivot on each of the pair of first wheels 18 when the second axle 22 is in the lifted position such that the user 60 can steer the tandem axle trailer 12 when the user 60 is pushing the tandem axle trailer 12. Each second wheel of the pair of second wheels 58 has a hub 62 and the hub 62 of each second wheel of the pair of second wheels 58 is rotatably coupled to a respective one of the first end 24 and the second end 26 of the second axle 22.

A drive box 64 is mounted to the tandem axle trailer 12 and the drive box 64 has a pair of inputs 66 and an output 67. Additionally, each input 66 of the pair of inputs 66 is in mechanical communication with the output 67. The output 67 is rotated when either of the pair of inputs 66 is rotated and each input 66 of the pair of inputs 66 has a rotational axis which is oriented perpendicular to a rotational axis of the output 67. The drive box 64 has a first lateral side 68 and a second lateral side 70 and a back side 72. Each input 66 of the pair of inputs 66 is located on a respective one of the first lateral side 68 and the second lateral side 70; the output 67 is located on the back side 72. The drive box 64 may include a series of drive gears which translate torque in a perpendicular angle between the pair of inputs 66 and the output 67 or other type of drive system that can translate torque in a perpendicular manner.

A sleeve 74 is coupled to the output 67 of the drive box 64 and the sleeve 74 is rotated when the output 67 rotates. A screw 76 is threadably coupled to the sleeve 74 and the screw 76 is coupled to the second axle 22. The screw 76 is extended outwardly from the sleeve 74 when the sleeve 74 is rotated in a first direction such that the second axle 22 is urged into the lowered position when the sleeve 74 is rotated in the first direction. Conversely, the screw 76 is retracted into the sleeve 74 when the sleeve 74 is rotated in a second direction such that the second axle 22 is urged into the lifted position when the sleeve 74 is rotated in the second direction.

The sleeve 74 has a coupled end 78 which is coupled to the output 67 of the drive box 64 and the sleeve 74 has a free end 80 which is open into an interior of the sleeve 74. The sleeve 74 has an inside surface 82 and the inside surface 82 is threaded. Furthermore, the sleeve 74 is rotated about an axis extending between the coupled end 78 and the free end 80 when the output 67 rotates. The screw 76 has an outer surface 84 and the outer surface 84 is threaded. Furthermore, the screw 76 extends into the free end 80 of the sleeve 74 and the outer surface 84 threadably engages the inside surface 82 of the sleeve 74. Additionally, the screw 76 has a distal end 86 with respect to the free end 80 of the sleeve 74.

An annular coupler 88 extends around the medial section 32 of the second axle 22. The annular coupler 88 has an outside surface 90 and the distal end 86 of the screw 76 is coupled to the outside surface 90. The medial section 32 of the second axle 22 is urged toward the sleeve 74 when the screw 76 is retracted into the sleeve 74. Conversely, the medial section 32 of the second axle 22 is urged away from the sleeve 74 when the screw 76 is extended from the sleeve 74.

A crank 92 is releasably mateable to a respective one of the pair of inputs 66 of the drive box 64 and the crank 92 can be rotated by the user 60. The sleeve 74 is rotated in the first direction when the crank 92 is rotated in a primary direction. Conversely, the second axle 22 is urged into the lowered position when the crank 92 is rotated in the primary direction. The sleeve 74 is rotated in the second direction when the crank 92 is rotated in a secondary direction. Conversely, the second axle 22 is urged into the lifted position when the crank 92 is rotated in the secondary direction.

The crank 92 includes a coupling portion 94 which is perpendicular to a middle portion 96. The crank 92 includes a handle 98 which is rotatably coupled to the middle portion 96 such that the handle 98 can be gripped by the user 60. The handle 98 extends in an opposite direction from the middle portion 96 with respect to the coupling portion 94. Furthermore, the handle 98 extends away from the drive box 64 toward the user 60 when the user 60 is standing next to the drive box 64. The coupling portion 94 is releasably mateable to the respective input of the drive box 64.

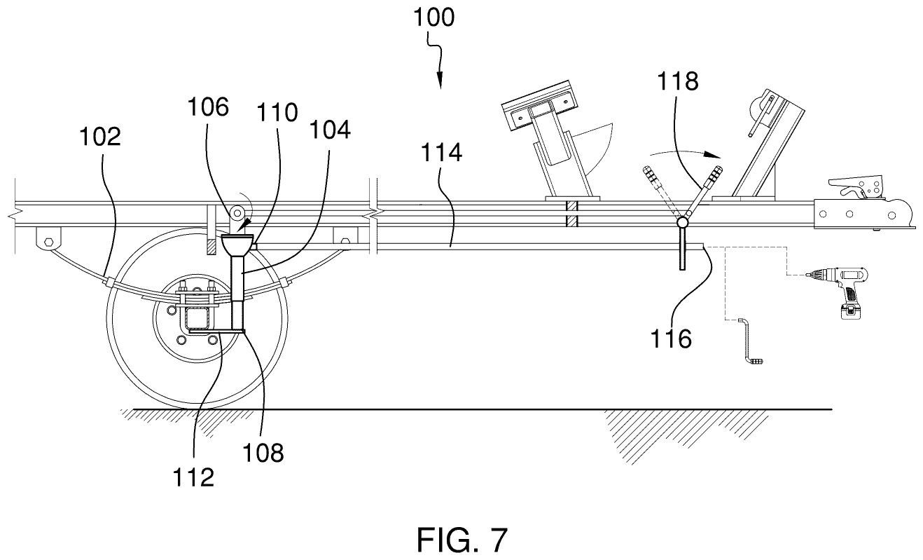

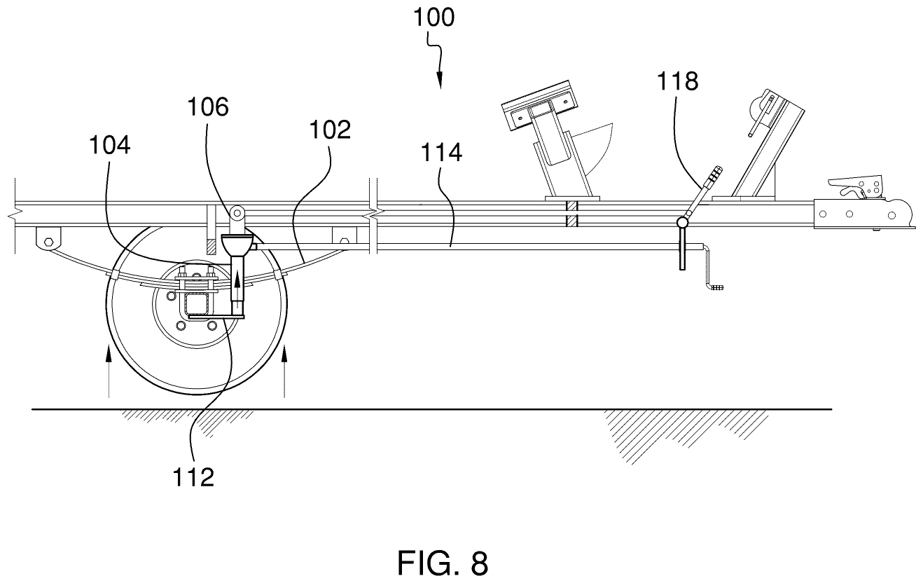

In an alternative embodiment 100 as shown in FIGS. 7 and 8, the tandem axle trailer 12 includes leaf springs 102 and the second axle 22 is supported by the leaf springs 102. A jack 104 is included which has a top end 106 that is pivotally coupled to the tandem axle trailer 12. The jack 104 has a bottom end 108 and the jack 104 has a telescopically adjustable length between the top end 106 and the bottom end 108. The jack 104 has a jack input 110; the jack 104 includes a foot 112 extending laterally away from the jack 104 and the foot 112 is aligned with the bottom end 108. Furthermore, the jack 104 may comprise a hydraulic jack, a mechanized jack or any other type of jack that would commonly be employed for jacking a trailer or a vehicle. The second axle 22 may comprise a solid axle of any conventional design that is commonly employed with leaf spring suspensions.

The jack 104 is pivotable into a deployed position having the jack 104 downwardly from the tandem axle trailer 12. Additionally, the foot 112 extends beneath the second axle 22 when the jack 104 is pivoted into the deployed position. The jack 104 is pivotable into a stored position having the jack 104 extending lengthwise along the tandem axle trailer 12. Additionally, the foot 112 is displaced from beneath the second axle 22 when the jack 104 is in the stored position.

The jack 104 is shortened when the jack input 110 is rotated in a first direction. The foot 112 lifts upwardly on the second axle 22 when the jack 104 is in the deployed position and the input is rotated in the first direction. Furthermore, the second axle 22 is urged into the lifted position when foot 112 lifts upwardly on the second axle 22 and the leaf springs 102 is compressed against a spring force of the leaf springs 102 when the foot 112 lifts upwardly on the second axle 22. The jack 104 is lengthened when the jack input 110 is rotated in a second direction. Additionally, the leaf springs 102 bias the second axle 22 to travel into the lifted position when the jack 104 is lengthened.

The alternative embodiment 100 includes a rod 114 which is coupled to the jack input 110. The rod 114 has a distal end 116 with respect to the jack input 110 and the rod 114 is oriented to extend lengthwise along the tandem axle trailer 12. The alternative embodiment 100 includes a lever 118 which is pivotally coupled to the tandem axle trailer 12 and the lever 118 is in mechanical communication with the rod 114. The rod 114 urges the jack 104 into the stored position when the lever 118 is pivoted into a storing position. Conversely, the rod 114 urges the jack 104 into the deployed position when the lever 118 is pivoted into a deploying position. The coupling portion 94 of the crank 92 is releasably mateable to the distal end 116 of the rod 114 to urge the second axle 22 into either the lowered position or the lifted position when the user 60 rotates the crank 92.

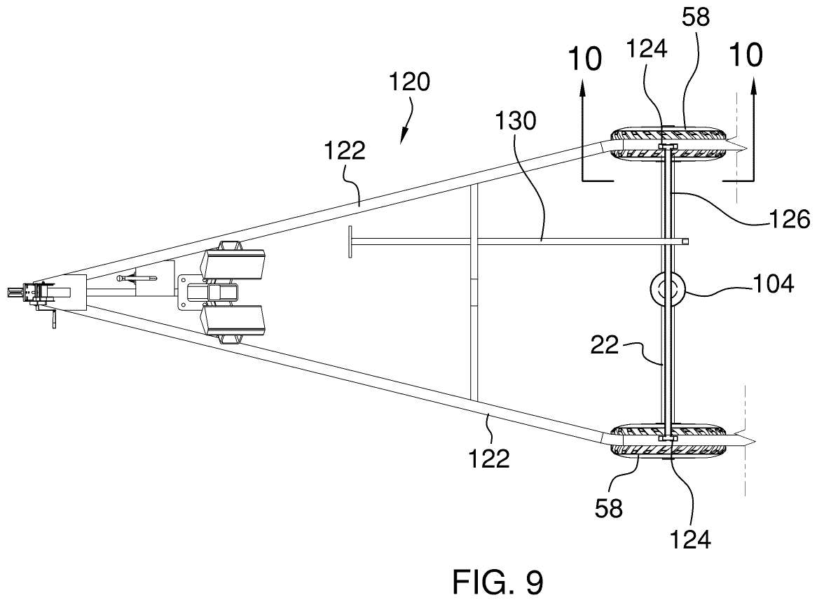

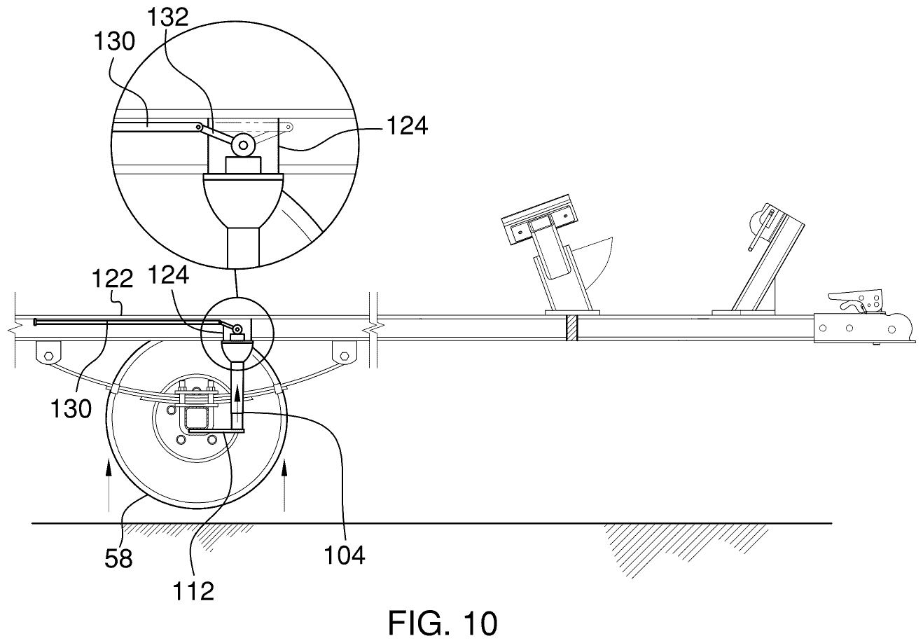

In an alternative embodiment 120 as shown in FIGS. 9 and 10, the tandem axle trailer 12 includes a pair of outer frame members 122 and each of the pair of outer frame members 122 is hollow. The alternative embodiment 100 includes a pair of bushing housings 124 each positioned within a respective one of the pair of outer frame members 122 and a rotating shaft 126 that is rotatably coupled between the pair of bushing housings 124. Additionally, each of the pair of bushing housings 124 may include a friction reducing bushing through which the rotating shaft 126 extends or other type of bearing. The top end 106 of the jack 104 is attached to the rotating shaft 126 at a point located between pair of bushing housings 124.

The alternative embodiment 120 includes a positioning rod 130 that is slidably mounted to the tandem axle trailer 12 and a linkage 132 that is pivotally coupled between the positioning rod 130 and the rotating shaft 126. The rotating shaft 126 is rotated in a first direction when positioning rod 130 is urged toward the rotating shaft 126. Additionally, the jack 104 is urged into the deployed position when the rotating shaft 126 is rotated in the first direction. The foot 112 extends beneath the second axle 22 when the jack 104 is pivoted into the deployed position. The rotating shaft 126 is rotated in a second direction when the positioning rod 130 is urged away from the rotating shaft 126. Additionally, the jack 104 is urged into the stored position when the rotating shaft 126 is rotated in the second direction. The foot 112 is displaced from beneath the second axle 22 when the jack 104 is in the stored position.

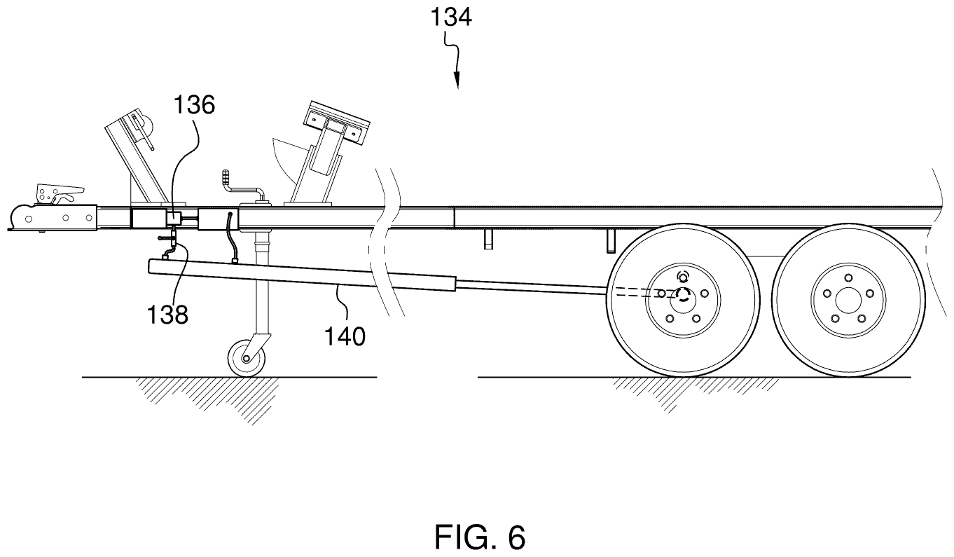

In an alternative embodiment 134 as shown in FIG. 6, the device includes a hydraulic pump 136 which is mounted to the tandem axle trailer 12. A control valve 138 is mounted to the tandem axle trailer and the control valve 138 is in fluid communication with the hydraulic pump 136. The control valve 138 is urgeable into a supply position and the control valve 138 is urgeable into a return position. A hydraulic piston 140 is mounted to the tandem axle trailer 12 and the hydraulic piston 140 is attached to the medial section 32 of the second axle 22. Additionally, the hydraulic piston 140 is in fluid communication with the control valve 138. The hydraulic piston 140 is elongated when the control valve 138 is urged into the supply position and the second axle 22 is urged into the lowered position when the hydraulic piston 140 is elongated. Conversely, the hydraulic piston 140 is shortened when the control valve 138 is urged into the supply position and the second axle 22 is urged into the lifted position when the hydraulic piston 140 is shortened.

In use, the tandem axle trailer 12 is uncoupled from the tow vehicle 14 such that the user 60 is able to manually push the tandem axle trailer 12. The user 60 mates the coupling portion 94 of the crank 92 to a chosen one of the pair of inputs 66 of the drive box 64 and the crank 92 is rotated in the secondary direction to rotate the second axle 22 into the lifted position and subsequently lift the pair of second wheels 58 from the support surface 20. The tandem axle trailer 12 will easily pivot on the pair of first wheels 18 when the pair of second wheels 58 are lifted from the support surface 20 such that the user 60 can steer the tandem axle trailer 12 while the user 60 is manually pushing the tandem axle trailer 12. The crank 92 is rotated in the primary direction to rotate the second axle 22 into the lowered position and subsequently lower the pair of second wheels 58 onto the support surface 20 prior to towing the tandem axle trailer 12 with the tow vehicle 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A tandem axle trailer lift device comprising:
a tandem axle trailer;
a first axle being mounted to said tandem axle trailer;
a pair of first wheels, each first wheel of said pair of first wheels being rotatably disposed on said first axle wherein each first wheel of said pair of first wheels is configured to roll along a support surface;
a second axle being pivotally attached to said tandem axle trailer, said second axle being positionable in a lowered position, said second axle being positionable in a lifted position;
a pair of second wheels, each second wheel of said pair of second wheels being rotatably disposed on said second axle wherein each second wheel of said pair of second wheels is configured to roll along the support surface when said second axle is in said lowered position, each second wheel of said pair of second wheels being lifted upwardly with respect to said pair of first wheels when said second axle is in said lifted position wherein each second wheel of said pair of second wheels is configured to be lifted from the support surface such that a user can steer said tandem axle trailer on said pair of first wheels;
a drive box being mounted to said tandem axle trailer, said drive box having a pair of inputs and an output, each input of said pair of inputs being in mechanical communication with said output, said output being rotated when either of said pair of inputs is rotated;
a sleeve being coupled to said output of said drive box, said sleeve being rotated when said output rotates;
a screw being threadably coupled to said sleeve, said screw being coupled to said second axle, said screw being extended outwardly from said sleeve when said sleeve is rotated in a first direction, said second axle being urged into said lowered position when said sleeve is rotated in said first direction, said screw being retracted into said sleeve when said sleeve is rotated in a second direction, said second axle being urged into said lifted position when said sleeve is rotated in said second direction; and
a crank being releasably mateable to a respective one of said pair of inputs of said drive box wherein said crank is configured to be rotated by the user, said sleeve being rotated in said first direction when said crank is rotated in a primary direction, said second axle being urged into said lowered position when said crank is rotated in said primary direction, said sleeve being rotated in said second direction when said crank is rotated in a secondary direction, said second axle being urged into said lifted position when said crank is rotated in said secondary direction.

2. The tandem axle trailer lift device according to claim 1, wherein:
said second axle has a first end and a second end;
said second axle has a pair of first bends;
said second axle has a pair of second bends;
said pair of first bends curve in opposite directions from each other;
said pair of second bends curve in opposite directions from each other;
said pair of first bends is positioned closer to said first end than said second end;
said pair of second bends is positioned closer to said second end than said first end;
said pair of first bends and said pair of second bends define a medial section of said second axle which extends between each of a first outward section of said second axle and a second outward section of said second axle;
said first outward section extends from said medial section toward said first end; and
said second outward section extends from said medial section toward said second end.

3. The tandem axle trailer lift device according to claim 2, wherein said medial section extends along a lengthwise axis being oriented parallel to a lengthwise axis of said first outward section and a lengthwise axis of said second outward section.

4. The tandem axle trailer lift device according to claim 3, wherein:
said second axle has a pair of third bends;
said pair of third bends curve in opposite directions from each other;
said pair of third bends is positioned closer to said first end than said pair of first bends; and
said pair of third bends defines a first coupling section of said second axle;
said first coupling section extends between an outermost one of said pair of third bends and said first end; and
said first coupling section extends along a lengthwise axis being aligned with said lengthwise axis of said medial section.

5. The tandem axle trailer lift device according to claim 4, wherein:
said second axle has a pair of fourth bends;
said pair of fourth bends curve in opposite directions from each other;
said pair of fourth bends is positioned closer to said second end than said pair of second bends; and
said pair of fourth bends define a second coupling section of said second axle;
said second coupling section extends between an outermost one of said pair of fourth bends and said second end; and
said second coupling section extends along a lengthwise axis being aligned with a lengthwise axis of said medial section.

6. The tandem axle trailer lift device according to claim 5, wherein each of said medial section and said first coupling section and said second coupling section is spaced downwardly from each of said first outward section and said second outward section when said second axle is in said lowered position.

7. The tandem axle trailer lift device according to claim 5, wherein each of said medial section and said first coupling section and said second coupling section is spaced forwardly from each of said first outward section and said second outward section when said second axle is in said lifted position.

8. The tandem axle trailer lift device according to claim 2, wherein:
said tandem axle trailer lift device includes a pair of hangers;
each hanger of said pair of hangers has an upper end being coupled to said tandem axle trailer;
each hanger of said pair of hangers extends downwardly from said tandem axle trailer;
each hanger of said pair of hangers has a lower end;
each hanger of said pair of hangers has a pivot point being aligned with said lower end;
said first outward section of said second axle extends through said pivot point of a respective one of said pair of hangers;
said second outward section of said second axle extends through said pivot point of a respective one of said pair of hangers; and
said second axle rotates about said lengthwise axis of said first outward section and said lengthwise axis of said second outward section when said second axle is moved between said lowered position and said lifted position.

9. The tandem axle trailer lift device according to claim 2, wherein:
each second wheel of said pair of second wheels has a hub; and
said hub of each second wheel of said pair of second wheels is rotatably coupled to a respective one of said first end and said second end of said second axle.

10. The tandem axle trailer lift device according to claim 1, wherein:
each input of said pair of inputs of said drive box has a rotational axis being oriented perpendicular to a rotational axis of said output of said drive box;
said drive box has a first lateral side and a second lateral side and a back side;
each input of said pair of inputs is located on a respective one of said first lateral side and said second lateral side; and
said output is located on said back side.

11. The tandem axle trailer lift device according to claim 10, wherein:
said sleeve has a coupled end being coupled to said output of said drive box;
said sleeve has a free end being open into an interior of said sleeve;
said sleeve has an inside surface;
said inside surface is threaded; and
said sleeve is rotated about an axis extending between said coupled end and said free end when said output rotates.

12. The tandem axle trailer lift device according to claim 11, wherein:
said screw has an outer surface;
said outer surface is threaded;
said screw extends into said free end of said sleeve;
said outer surface threadably engages said inside surface of said sleeve; and
said screw has a distal end with respect to said free end of said sleeve.

13. The tandem axle trailer lift device according to claim 12, wherein:
said tandem axle trailer lift device includes an annular coupler extending around said medial section of said second axle;
said annular coupler has an outside surface;
said distal end of said screw is coupled to said outside surface;
said medial section of said second axle is urged toward said sleeve when said screw is retracted into said sleeve; and
said medial section of said second axle is urged away from said sleeve when said screw is extended from said sleeve.

14. The tandem axle trailer lift device according to claim 1, wherein:
said crank includes a coupling portion being perpendicular to a middle portion;
said crank includes a handle being rotatably coupled to said middle portion wherein said handle is configured to be gripped by the user;
said handle extends in an opposite direction from said middle portion with respect to said coupling portion wherein said handle is configured to extend away from said drive box toward the user when the user is standing next to said drive box; and
said coupling portion is releasably mateable to said respective input of said drive box.

15. A tandem axle trailer lift device comprising:
a tandem axle trailer;
a first axle being mounted to said tandem axle trailer;
a pair of first wheels, each first wheel of said pair of first wheels being rotatably disposed on said first axle wherein each first wheel of said pair of first wheels is configured to roll along a support surface;
a second axle being pivotally attached to said tandem axle trailer, said second axle being positionable in a lowered position, said second axle being positionable in a lifted position, said second axle having a first end and a second end, said second axle having a pair of first bends, said second axle having a pair of second bends, said pair of first bends curving in opposite directions from each other, said pair of second bends curving in opposite directions from each other, said pair of first bends being positioned closer to said first end than said second end, said pair of second bends being positioned closer to said second end than said first end, said pair of first bends and said pair of second bends defining a medial section of said second axle which extends between each of a first outward section of said second axle and a second outward section of said second axle, said first outward section extending from said medial section toward said first end, said second outward section extending from said medial section toward said second end, said medial section extending along a lengthwise axis being oriented parallel to a lengthwise axis of said first outward section and a lengthwise axis of said second outward section, said second axle having a pair of third bends, said pair of third bends curving in opposite directions from each other, said pair of third bends being positioned closer to said first end than said pair of first bends, said pair of third bends defining a first coupling section of said second axle, said first coupling section extending between an outermost one of said pair of third bends and said first end, said first coupling section extending along a lengthwise axis being aligned with said lengthwise axis of said medial section, said second axle having a pair of fourth bends, said pair of fourth bends curving in opposite directions from each other, said pair of fourth bends being positioned closer to said second end than said pair of second bends, said pair of fourth bends defining a second coupling section of said second axle, said second coupling section extending between an outermost one of said pair of fourth bends and said second end, said second coupling section extending along a lengthwise axis being aligned with said lengthwise axis of said medial section, each of said medial section and said first coupling section and said second coupling section being spaced downwardly from each of said first outward section and said second outward section when said second axle is in said lowered position, each of said medial section and said first coupling section and said second coupling section being spaced forwardly from each of said first outward section and said second outward section when said second axle is in said lifted position;
a pair of hangers, each hanger of said pair of hangers having an upper end being coupled to said tandem axle trailer, each hanger of said pair of hangers extending downwardly from said tandem axle trailer, each hanger of said pair of hangers having a lower end, each hanger of said pair of hangers having a pivot point being aligned with said lower end, said first outward section of said second axle extending through said pivot point of a respective one of said pair of hangers, said second outward section of said second axle extending through said pivot point of a respective one of said pair of hangers, said second axle rotating about said lengthwise axis of said first outward section and said lengthwise axis of said second outward section when said second axle is moved between said lowered position and said lifted position;
a pair of second wheels, each second wheel of said pair of second wheels being rotatably disposed on said second axle wherein each second wheel of said pair of second wheels is configured to roll along the support surface when said second axle is in said lowered position, each second wheel of said pair of second wheels being lifted upwardly with respect to said pair of first wheels when said second axle is in said lifted position wherein each second wheel of said pair of second wheels is configured to be lifted from the support surface such that a user can steer said tandem axle trailer on said pair of first wheels, each second wheel of said pair of second wheels having a hub, said hub of each second wheel of said pair of second wheels being rotatably coupled to a respective one of said first end and said second end of said second axle;
a drive box being mounted to said tandem axle trailer, said drive box having a pair of inputs and an output, each input of said pair of inputs being in mechanical communication with said output, said output being rotated when either of said pair of inputs is rotated, each input of said pair of inputs having a rotational axis being oriented perpendicular to a rotational axis of said output, said drive box having a first lateral side and a second lateral side and a back side, each input of said pair of inputs being located on a respective one of said first lateral side and said second lateral side, said output being located on said back side;
a sleeve being coupled to said output of said drive box, said sleeve being rotated when said output rotates, said sleeve having a coupled end being coupled to said output of said drive box, said sleeve having a free end being open into an interior of said sleeve, said sleeve having an inside surface, said inside surface being threaded, said sleeve being rotated about an axis extending between said coupled end and said free end when said output rotates;
a screw being threadably coupled to said sleeve, said screw being coupled to said second axle, said screw being extended outwardly from said sleeve when said sleeve is rotated in a first direction, said second axle being urged into said lowered position when said sleeve is rotated in said first direction, said screw being retracted into said sleeve when said sleeve is rotated in a second direction, said second axle being urged into said lifted position when said sleeve is rotated in said second direction, said screw having an outer surface, said outer surface being threaded, said screw extending into said free end of said sleeve, said outer surface threadably engaging said inside surface of said sleeve, said screw having a distal end with respect to said free end of said sleeve;
an annular coupler extending around said medial section of said second axle, said annular coupler having an outside surface, said distal end of said screw being coupled to said outside surface, said medial section of said second axle being urged toward said sleeve when said screw is retracted into said sleeve, said medial section of said second axle being urged away from said sleeve when said screw is extended from said sleeve; and
a crank being releasably mateable to a respective one of said pair of inputs of said drive box wherein said crank is configured to be rotated by the user, said sleeve being rotated in said first direction when said crank is rotated in a primary direction, said second axle being urged into said lowered position when said crank is rotated in said primary direction, said sleeve being rotated in said second direction when said crank is rotated in a secondary direction, said second axle being urged into said lifted position when said crank is rotated in said secondary direction, said crank including a coupling portion being perpendicular to a middle portion, said crank including a handle being rotatably coupled to said middle portion wherein said handle is configured to be gripped by the user, said handle extending in an opposite direction from said middle portion with respect to said coupling portion wherein said handle is configured to extend away from said drive box toward the user when the user is standing next to said drive box, said coupling portion being releasably mateable to said respective input of said drive box.

15. The device according to claim 14, wherein:
said device includes a hydraulic pump being mounted to said tandem axle trailer;
a control valve being mounted to said tandem axle trailer, said control valve being in fluid communication with said hydraulic pump, said control valve being urgeable into a supply position, said control valve being urgeable into a return position; and
a hydraulic piston being mounted to said tandem axle trailer, said hydraulic piston being attached to said medial section of said second axle, said hydraulic piston being in fluid communication with said control valve, said hydraulic piston being elongated when said control valve is urged into said supply position, said second axle being urged into said lowered position when said hydraulic piston is elongated, said hydraulic piston being shortened when said control valve is urged into said supply position, said second axle being urged into said lifted position when said hydraulic piston is shortened.

16. The device according to claim 14, wherein:
said tandem axle trailer includes leaf springs, said second axle being supported by said leaf springs;
said device includes a jack having a top end being pivotally coupled to said tandem axle trailer, said jack having a bottom end, said jack having a telescopically adjustable length between said top end and said bottom end, said jack having a jack input, said jack includes a foot extending laterally away from said jack, said foot being aligned with said bottom end;
said jack is pivotable into a deployed position having said jack downwardly from said tandem axle trailer, said foot extending beneath said second axle when said jack is pivoted into said deployed position;
said jack is pivotable into a stored position having said jack extending lengthwise along said tandem axle trailer, said foot being displaced from beneath said second axle when said jack is in said stored position;
said jack is shortened when said jack input is rotated in a first direction, said foot lifting upwardly on said second axle when said jack is in said deployed position and said input is rotated in said first direction, said second axle being urged into said lifted position when foot lifts upwardly on said second axle, said leaf springs being compressed against a spring force of said leaf springs when said foot lifts upwardly on said second axle; and
said jack is lengthened when said jack input is rotated in a second direction, said leaf springs biasing said second axle to travel into said lifted position when said jack is lengthened.

17. The device according to claim 16, wherein:
said device includes a rod being coupled to said jack input, said rod having a distal end with respect to said jack input, said rod being oriented to extend lengthwise along said tandem axle trailer;
a lever being pivotally coupled to said tandem axle trailer, said lever being in mechanical communication with said rod, said rod urging said jack into said stored position when said lever is pivoted into a storing position, said rod urging said jack into said deployed position when said lever is pivoted into a deploying position; and
said coupling portion of said crank is releasably mateable to said distal end of said rod wherein said crank is configured urge said second axle into either said lowered position or said lifted position when the user rotates said crank.
